(19) United States
(12) Patent Application Publication
(10) Pub. No.: US 2013/0159779 A1
(43) Pub. Date: Jun. 20, 2013

(54) FRAMEWORK FOR THE REMOTE DEBUGGING OF WEB APPLICATIONS

(71) Applicant: James W. Mickens, Bellevue, WA (US)

(72) Inventor: James W. Mickens, Bellevue, WA (US)

(73) Assignee: Microsoft Corporation, Redmond, WA (US)

(21) Appl. No.: 13/329,335

(22) Filed: Dec. 19, 2011

(51) Int. Cl. G06F 11/00

(52) U.S. Cl. 714/38.14; 714/E11.21

(57) ABSTRACT

In one embodiment, a remote debugging infrastructure may allow a local application 114 to be debugged in real time. A remote debugging operator 120 may establish a connection with an execution platform 112 via a local application 114 activated by the execution platform 112. The remote debugging operator 120 may access an operational state of the local application 114.

### BACKGROUND

Even the most meticulously coded software application may have errors, referred to as “bugs.” The process of correcting these errors is referred to as “debugging”. While extensive debugging may occur during construction of the code, many bugs may often not be readily apparent until the application has been executed in real world conditions. If an error causes an application to fail, referred to as a “crash”, an operating system or the application may compile an error report to be sent to the software designer so that the error may be corrected.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to allowing a remote debugging infrastructure to debug a local application in real time. A remote debugging operator may establish a connection with an execution platform via a local application activated by the execution platform. The remote debugging operator may access an operational state of the local application.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a network supporting a remote debugging infrastructure.

FIG. 2 illustrates, in a block diagram, one embodiment of a computing device.

FIG. 3 illustrates, in a block diagram, one embodiment of a user interface for a remote debugging infrastructure.

FIG. 4 illustrates, in a flowchart, one embodiment of a method for executing a remote debugging session from the perspective of a user device.

FIG. 5 illustrates, in a flowchart, one embodiment of a method for pausing a local application.

FIG. 6 illustrates, in a flowchart, one embodiment of a method for executing a remote debugging session from the perspective of a remote debugging operator.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a remote debugging operator.

Although a browser may ship with a feature-rich JavaScript® debugger, such a debugger may typically examine a web-based application within the context of the local browser. A local browser is a browser being executed on a user device. The Javascript® debugger may be unable to debug web pages that run on a remote machine. Some browsers may support remote debugging, but the remote debugging in this instance may be tied to a specific browser type. Remote debugging is performed by a machine remote from the user device. Given the empirical diversity of browsers, and the inability of web developers to dictate the browsers that end-users employ, remote debugging frameworks that are tied to a particular browser engine may have poor coverage for discovering each bug. The quirks of individual browsers may be important inducers of bugs, so an effective remote debugger may be anchored within the application being debugged to inspect pages that run atop arbitrary, unmodified commodity browsers.

A remote debugging infrastructure may debug local or remote applications written in reflective, event driven languages. A local application is an application being executed on a user device, while a remote application is an application executed on a device remote from the user device. A local application may have one or more event contexts. An event context is an application module in which each module has an event loop for handling user input, network events, and other factors. The remote debugging framework may operate without modification to the execution platform. An execution platform is a software system that configures the user device to execute the local program, such as a language interpreter. If the execution platform is a web browser, a remote debugging infrastructure may debug a local or remote web application without modifications to the end browser. The remote debugging infrastructure may be executed by any arbitrary browser that supports the JavaScript® language.

The remote debugging infrastructure may pause a local application using hierarchical pause notifications. Each pause notification may pause an event context by establishing a synchronous network connection with the remote debugging operator. A local application may have one or more event contexts each having an event loop. To pause an application, the remote debugging operator may send a pause message to the top-most event context. In turn, the event context may send pause messages to each descendant in the context hierarchy. The pause process may happen recursively, with the child event context forwarding pause messages to the grandchild event contexts of the top-most context, and so on. When a pause message reaches an event context with no child event contexts, that event context may send a pause confirmation message to its parent event context. The event context may then open a synchronous connection to the remote debugger. The synchronous connection may effectively pause that event context, as other event context may queue up waiting for the blocking event handler to terminate. Once an event context with descendant event contexts receives pause confirmations from each descendant event context, that parent event context may send a pause confirmation to the grandparent event context and open a synchronous connection to a remote debugging operator. The pausing process may happen recursively until the entire application is paused. Once the entire application is paused, the remote debugging operator may send debugging commands to each context, such as reading an operation state or assign a new value to an operation state.

A remote debugging client module in the local application may make a remote operation state visible to the remote debugging operator by taking advantage of language introspection or application rewriting. An operation state may be an object property, a closure variable, an event handler, and other operational characteristics. In a dynamic, reflective language like Python® or JavaScript®, a local application may inspect an operation state at runtime by enumerating the properties of an object, dynamically adding or removing properties, or other processes. Once the remote debugging operator has established a connection with a local application written in a dynamic, reflexive language, the remote debugging operator may inspect many types of states using standard reflection properties provided by the language. However, some local application properties, such as closures, may not present an explicit manipulation interface. To expose such an operation state to the remote debugging operator, the debugging client module may rewrite certain portions of code to create “view” objects that provide an explicit interface to normally obscured state. For example, the debugging client module may rewrite each closure object to have an explicit function that exposes normally hidden closure variables. Once the remote debugging operator has connected to the local application, the remote debugging operator may call this function to examine normally hidden closure states.

The remote debugging infrastructure may implement breakpoints as a two-way dialog between an event context and a remote debugging operator. Once the remote debugging operator has established a connection with local application, the remote debugging operator may dynamically rewrite the code of the local application, taking advantage of the dynamic modification facilities provided by the dynamic language in which the local application is written. The remote debugging operator may rewrite the code to insert a breakpoint in a function. This breakpoint may behave like a breakpoint in a standard debugger, causing the local application to pause and connect to the remote debugging operator when the execution hits the breakpoint statement. To implement the breakpoint, the remote debugging operator may first pause the entire application. Then, the remote debugging operator may send a series of debugging commands to the event context that contains the breakpoint. For example, these debugging commands may fetch remote state or set remote state to new values. To implement such commands, the remote debugging operator may take advantage of the ability of the dynamic language to evaluate code at runtime. The remote debugging operator may send code to the local application, which then executes the code and sends the result back to the remote debugging operator.

The remote debugging operator may install live patches, such as dynamically updating variables, function definitions, and other fixes. The remote debugging operator may exploit the reflective nature of the runtime and the ability to pause to safely install updates in an atomic manner. By taking advantage of the native introspection capabilities of a dynamic language, the remote debugging operator may radically change the state of the running application. For example, the remote debugging operator may install live patches making wide scale changes to function definitions or data structure definitions. The remote debugging infrastructure may provide convenient functions to automate many useful patching tasks. For example, the remote debugging operator may define an automatic method to redefine a class. The remote debugging operator may locate each instance of the old class, transforms these instances to instances of the new class, and then replaces each reference to the old class definition with a reference to the new class definitions.

Thus, in one embodiment, a remote debugging infrastructure may allow a local application to be debugged in real time. A remote debugging operator may establish a connection with an execution platform via a local application activated by the execution platform. The remote debugging operator may access an operational state of the local application.

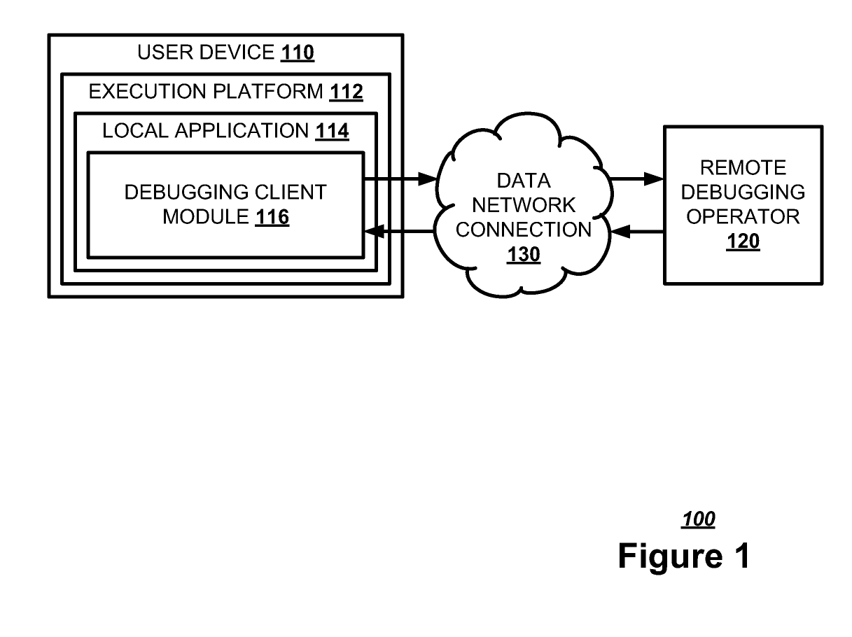

FIG. 1 illustrates, in a block diagram, one embodiment of a network 100 supporting a remote debugging infrastructure. A user device 110 may implement an execution platform 112 that executes a local application 114. An execution platform 112 is a software environment that adapts a user device 110 to execute an application, such as an operating system or a web browser. A local application 114 is any application being run on a user device 110, such as a software application or a web-based application.

If the local application 114 encounters an error, or “bug”, that impairs the functioning of the local application 114 in the user device 110, a debugging client module 116 in the local application 114 may contact a remote debugging operator 120 over a data network connection 130. The remote debugging operator 120 is a computer system that acts to correct a software error in the local application 114. The remote debugging operator 120 may act automatically following a software application or may be guided by a human administrator. The data network connection 130 may be any medium for transmitting data communications, such as the internet.

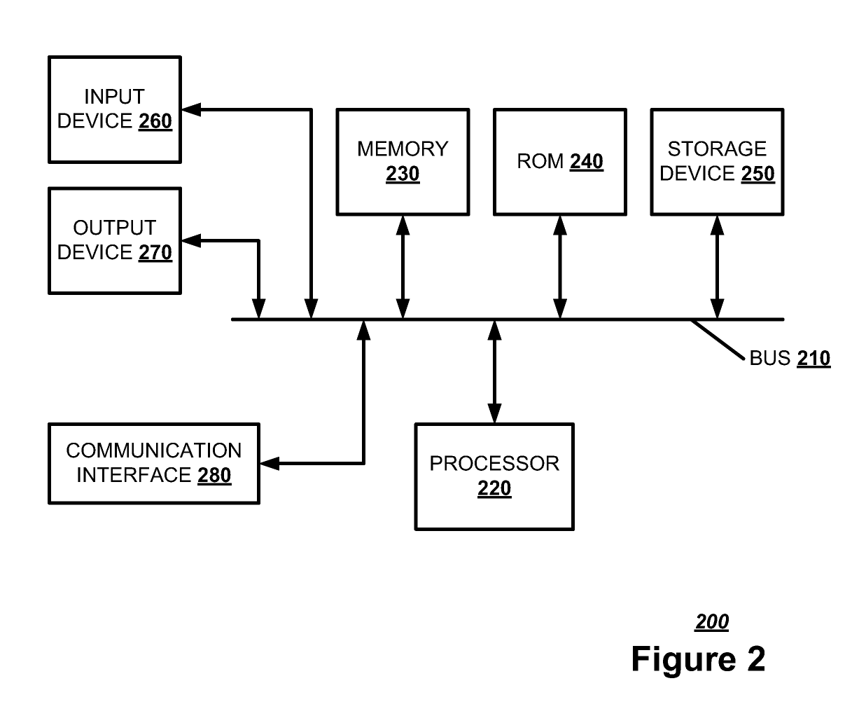

FIG. 2 illustrates a block diagram of an exemplary computing device 200 which may act as a user device 110 or a remote debugging operator 120. The computing device 200 may combine one or more of hardware, software, firmware, and system-on-a-chip technology to implement the remote debugging infrastructure. The computing device 200 may include a bus 210, a processor 220, a memory 230, a read only memory (ROM) 240, a storage device 250, an input device 260, an output device 270, and a communication interface 280. The bus 210 may permit communication among the components of the computing device 200.

The processor 220 may include at least one conventional processor or microprocessor that interprets and executes a set of instructions. The memory 230 may be a random access memory (RAM) or another type of dynamic storage device that stores information and instructions for execution by the processor 220. The memory 230 may also store temporary variables or other intermediate information used during execution of instructions by the processor 220. The ROM 240 may include a conventional ROM device or another type of static storage device that stores static information and instructions for the processor 220. The storage device 250 may include any type of tangible machine-readable medium, such as, for example, magnetic or optical recording media and its corresponding drive. A tangible machine-readable medium is a physical medium storing machine-readable code or instructions, as opposed to a transitory medium or signal. The storage device 250 may store a set of instructions detailing a method that when executed by one or more processors cause the one or more processors to perform the method. The storage device 250 may also be a database or a database interface for storing automatic patches to the local application 114.

The input device 260 may include one or more conventional mechanisms that permit a user to input information to the computing device 200, such as a keyboard, a mouse, a touch screen, a voice recognition device, a microphone, a headset, etc. The output device 270 may include one or more conventional mechanisms that output information to the user, including a display, a printer, one or more speakers, a headset, or a medium, such as a memory, or a magnetic or optical disk and a corresponding disk drive. The communication interface 280 may include any transceiver-like mechanism that enables computing device 200 to communicate with other devices or networks. The communication interface 280 may include a network interface or a mobile transceiver interface. The communication interface 280 may be a wireless, wired, or optical interface.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the storage device 250, or from a separate device via the communication interface 280.

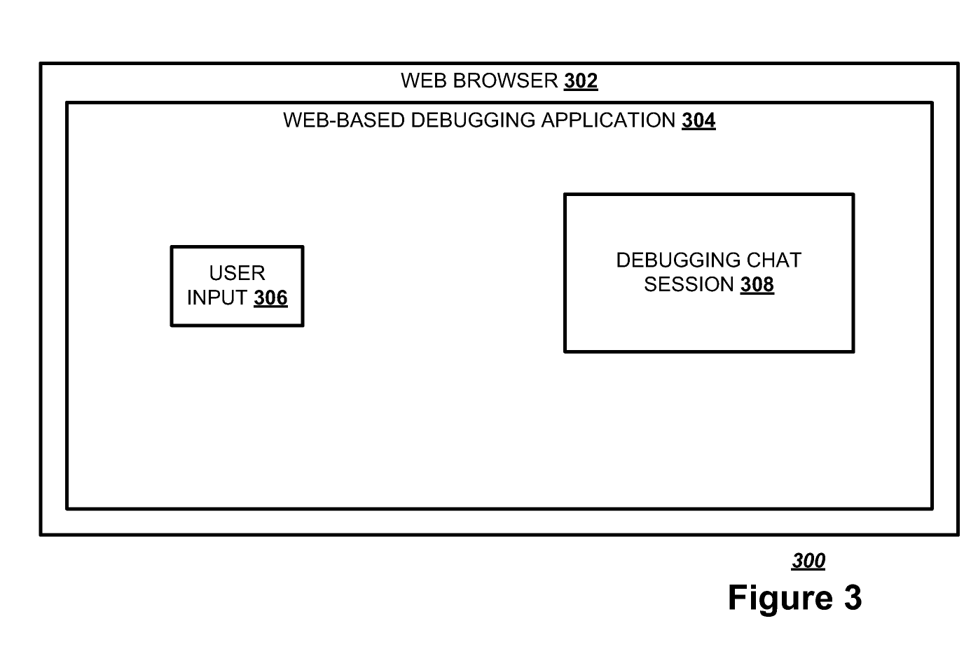

FIG. 3 illustrates, in a block diagram, one embodiment of a method for executing a remote debugging session at a user device. The user interface 300 may display a web browser 302 executing a web-based debugging application 304. A web-based debugging application 304 is an application provided by a web site at least partially executed on a user device 110. The web-based debugging application 304 may be a Java® enabled application. The web-based debugging application 304 may provide a user input 306 to the user that allows the user to indicate that the web-based application is acting improperly. The user input 306 may be a virtual button or a hyperlink.

Upon encountering a bug, the web-based debugging application 304 may establish a connection to the remote debugging operator 120. The web-based debugging application 304 may create a debugging chat session module 308 so that the user may interact with a human administrator overseeing the remote debugging operator 120. Thus, the user may clearly describe the circumstances that caused the apparent bug to occur.

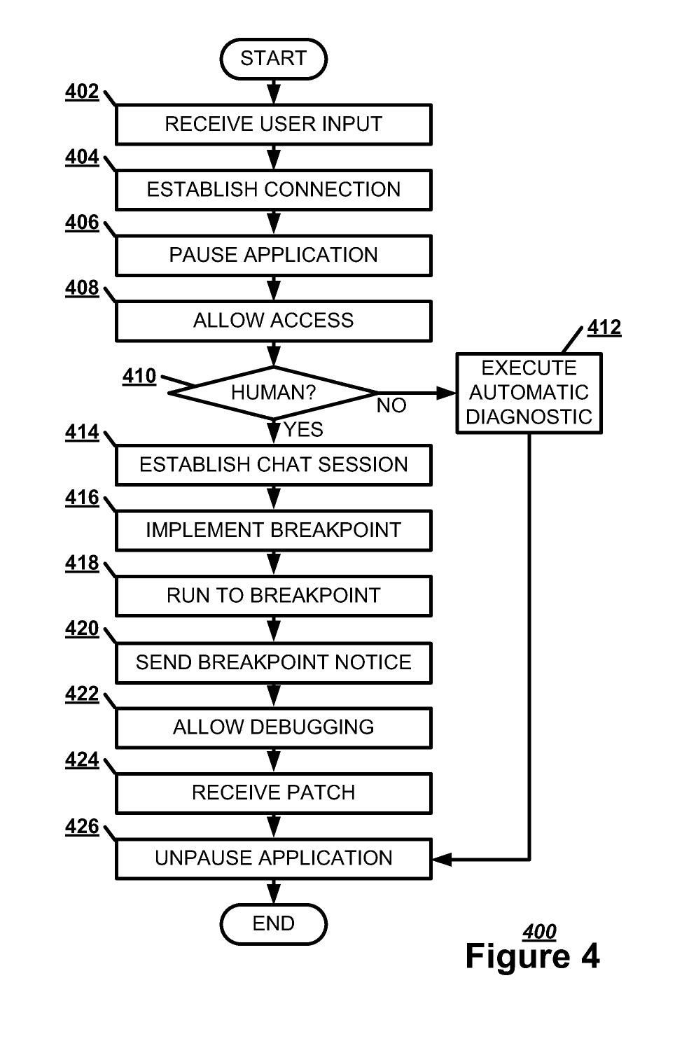

FIG. 4 illustrates, in a flowchart, one embodiment of a method 400 for reacting to a local application failure from the perspective of a user device 110. The user device 110 may receive a user input that initiates a connection to a remote debugging operator 120 (Block 402). The user device 110 may establish a connection between the remote debugging operator 120 and an execution platform 112 via a debugging client module 116 in a local application 114 activated by the execution platform 112 (Block 404). The user device 110 may pause the local application 114 upon receiving a pause instruction from the remote debugging operator 120 (Block 406). The user device 110 may allow the remote debugging operator 120 to access an operational state of the local application 114 (Block 408). If a human administrator is not available (Block 410), the user device 110 may execute an automatic diagnostic on the local application 114 initiated by the remote debugging operator 120 (Block 412).

The user device 110 may establish a debugging chat session with a live remote debugging operator 120 (Block 414). The user device 110 may implement a breakpoint in the local application 114 as directed by the remote debugging operator 120 (Block 416). The user device 110 may run the local application 114 until the breakpoint occurs (Block 418). The user device 110 may send a breakpoint notice to the remote debugging operator to indicate that a breakpoint has been reached (Block 420). The user device 110 may allow the remote debugging operator 120 to debug the local application 114 (Block 422). The user device 110 may receive a patch to the local application 114 from the remote debugging operator 120 (Block 424). The user device 110 may unpause the local application 114 (Block 426).

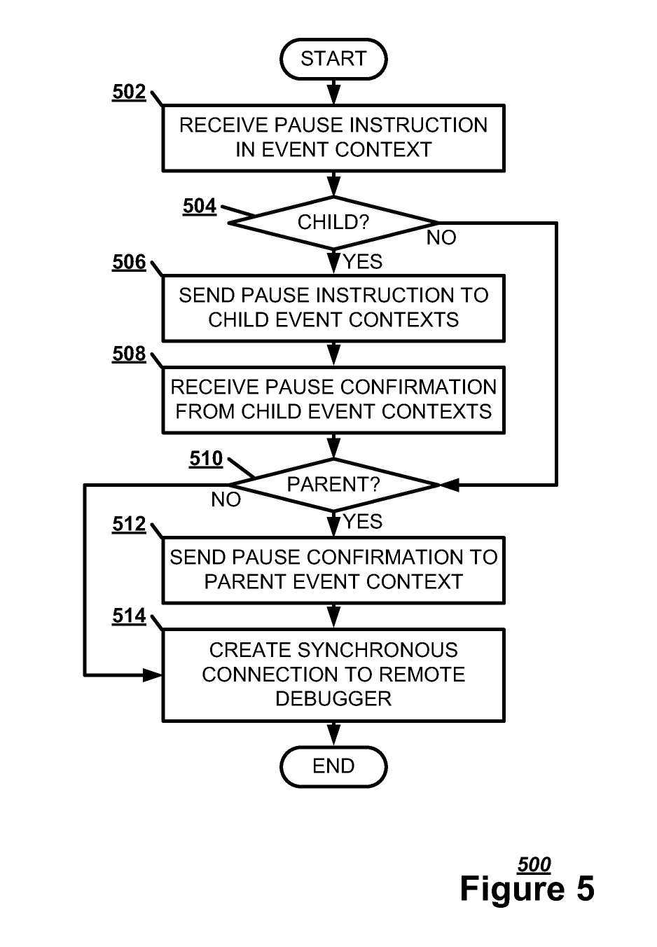

FIG. 5 illustrates, in a flowchart, one embodiment of a method 500 for pausing a local application 114. The local application 114 may receive a pause instruction in an event context from the remote debugging operator 120 (Block 502). If the event context has one or more child event contexts (Block 504), the event context may send the pause instruction to the one or more child event context (Block 506). The event context may receive a pause confirmation from each child event context (Block 508).

An event context may be a child event context in relation to a higher event context and a parent event context in relation to a lower event context. If the event context has a parent event context (Block 510), the event context may send the pause confirmation to the parent event context (Block 512). The event context may then create a synchronous connection to the remote debugging operator 120 (Block 514).

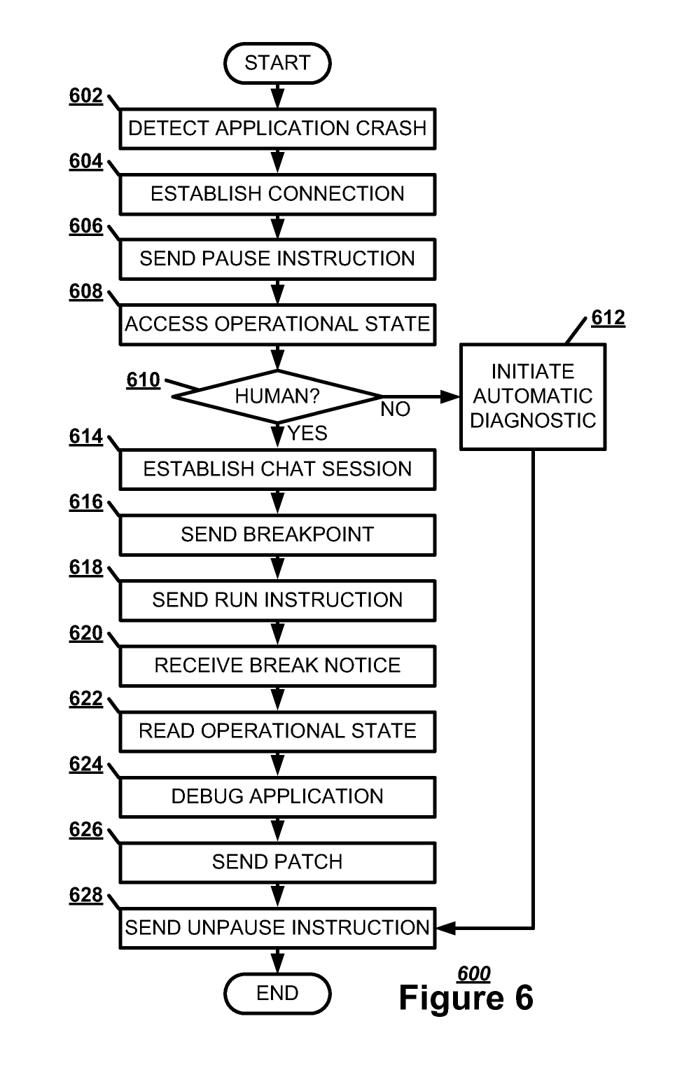

FIG. 6 illustrates, in a flowchart, one embodiment of a method 600 for executing a remote debugging session from the perspective of a remote debugging operator. The remote debugging operator 120 may detect an application crash of a local application 114 to trigger a connection (Block 602). The remote debugging operator 120 may detect the application crash through the user initiation of a connection or by an automatic detection mechanism in the local application 114. The remote debugging operator 120 may establish the connection with an execution platform 112 via a debugging client module 116 in a local application 114 activated by the execution platform 112 (Block 604). The remote debugging operator 120 may send a pause instruction (Block 606). The remote debugging operator 120 may access an operational state of the local application 114 (Block 608). The remote debugging operator 120 may use this access to execute at least one of a read operation or a write operation on the local application 114. If a human administrator is not present (Block 610), the remote debugging operator 120 may initiate an automatic diagnostic on the local application 114 (Block 612).

The remote debugging operator 120 may establish a debugging chat session with the local application 114 (Block 614). The remote debugging operator 120 may send a breakpoint instruction to the local application 114 (Block 616). The remote debugging operator 120 may send a run instruction to the local application 114 (Block 618). The remote debugging operator 120 may receive a break notice from the local application 114 indicating that a breakpoint has been reached (Block 620). The remote debugging operator 120 may read the operational state of the local application 114 (Block 622). The remote debugging operator 120 may debug the local application 114 (Block 624). The remote debugging operator 120 may send a patch to the local application 114 (Block 626). The remote debugging operator 120 may then send an unpause instruction to the local application 114 (Block 628).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include non-transitory computer-readable storage media for carrying or having computer-executable instructions or data structures stored thereon. Such non-transitory computer-readable storage media may be any available media that can be accessed by a general purpose or special purpose computer. By way of example, and not limitation, such non-transitory computer-readable storage media can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
establishing a connection between a remote debugging operator and an execution platform via a local application activated by the execution platform; and
allowing the remote debugging operator to access an operational state of the local application.

2. The method of claim 1, further comprising:
receiving a user input that initiates the connection.

3. The method of claim 1, further comprising:
executing an automatic diagnostic on the local application initiated by the remote debugging operator.

4. The method of claim 1, further comprising:
receiving a patch to the local application from the remote debugging operator.

5. The method of claim 1, further comprising:
pausing the local application upon receiving a pause instruction from the remote debugging operator.

6. The method of claim 1, further comprising:
receiving a pause instruction in an event context from the remote debugging operator; and
sending the pause instruction to a child event context.

7. The method of claim 6, further comprising:
creating a synchronous connection between the event context and the remote debugging operator.

8. The method of claim 1, further comprising:
allowing the remote debugging operator to debug the local application.

9. The method of claim 1, further comprising:
implementing a breakpoint in the local application as directed by the remote debugging operator.

10. The method of claim 1, further comprising:
establishing a debugging chat session with a live remote debugging operator.

11. A tangible machine-readable medium having a set of instructions detailing a method stored thereon that when executed by one or more processors cause the one or more processors to perform the method, the method comprising:
establishing a connection with a remote debugging operator to an execution platform via a local application activated by the execution platform; and
accessing with the remote debugging operator an operational state of the local application.

12. The tangible machine-readable medium of claim 11, wherein the method further comprises:
detecting an application crash of the local application to trigger the connection.

13. The tangible machine-readable medium of claim 11, wherein the method further comprises:
executing at least one of a read operation or a write operation on the local application.

14. The tangible machine-readable medium of claim 11, wherein the method further comprises:
sending a pause instruction from the remote debugging operator.

15. The tangible machine-readable medium of claim 11, wherein the method further comprises:
initiating an automatic diagnostic on the local application.

16. The tangible machine-readable medium of claim 11, wherein the method further comprises:
sending a patch to the local application.

17. The tangible machine-readable medium of claim 11, wherein the method further comprises:
reading the operation state of the local application.

18. The tangible machine-readable medium of claim 11, wherein the method further comprises:
sending a breakpoint instruction to the local application.

19. A remote debugging operator, comprising:
a communication interface that establishes a connection to a web browser via a web-based application activated by the web browser; and
a processor that accesses an operational state of the web-based application and debugs the local application.

20. The remote debugging operator of claim 19, wherein the processor initiates an automatic diagnostic on the web-based application.
